(19) United States
(12) Patent Application Publication
(10) Pub. No.: US 2015/0127404 A1
(43) Pub. Date: May 7, 2015

(54) Matching System for Real-Time Knowledge Sharing Between Knowledge Seekers and Knowledge Providers Offering Choice of Free and Fee-Based Services Across Multiple Categories and Subjects and Involving both Ad Hoc and Sheduled Knowledge Transfer Sessions Facilitated and Achieved Using Hybrid Network Topology Comprising Client-Server and Peer-To-Peer Functions

(71) Applicants: Frederick Hannon Laughter, Ramona, CA (US); Daniel Bateman, San Francisco, CA (US)

(72) Inventors: Frederick Hannon Laughter, Ramona, CA (US); Daniel Bateman, San Francisco, CA (US)

(21) Appl. No.: 14/070,282

(22) Filed: Nov. 1, 2013

(51) Int. Cl. G06Q 10/10; G06Q 50/00; G06Q 50/20

(52) U.S. Cl. CPC G06Q 10/103; G06Q 10/1095; G06Q 50/20; G06Q 50/01
USPC 705/7.19; 705/319

(57) ABSTRACT

System of matching algorithms for pairing parties wherein one party seeks and consumes knowledge and the other party provides knowledge by means of real-time knowledge transfer sessions conducted via video communications and multiple media. Knowledge can be transferred through collaborative problem solving, questions-and-answers, tutorials, structured sessions, and unstructured sessions. The transfer of knowledge can take place on a pay-for-service basis or by means of knowledge-gifting. The system can accommodate one-to-one, one-to-many, many-to-one, and many-to-many assemblages of knowledge sharing participates. The system includes post-session ratings of each party by and of the other party, building cumulative ratings scores, supplemented with video and voice and text reviews with the resultant data woven into an algorithmic solution for matching participants in future sessions with optimally favorable outcomes, based on the quantifiably expressed feedback of all session participants.

This application claims priority to U.S. Provisional Application 61/796,026 filed on Nov. 1, 2012 by inventor Fred H. Laughter and this application claims priority to U.S. Provisional Application 61/796,031 filed on Nov. 1, 2012 by inventor Fred H. Laughter, the entire disclosure of which is incorporated by reference.

### BACKGROUND OF THE INVENTION

1. Field of the Invention

The present invention is a matching system for pairing knowledge seekers and knowledge providers for real-time sessions of knowledge sharing and human skills transference. More specifically, the present invention is a system utilizing hybrid network topology with peer-to-peer functions and client-serve functions with centralized discovery platform and scheduling functions and decentralized knowledge transfer session technologies comprising peer-to-peer texting, audio, video, and multimedia technologies.

2. Description of the Related Art

The Internet has given rise to predominantly centralized social media, including social media with discovery platform capabilities for searching and finding resources including human resources with expertise of interest. There are peer-to-peer alternatives to centralized client-service topologies for social media, but peer-to-peer social media are less common.

The Internet and mobile cellular and wireless-fidelity also known as wifi technologies are used to enable commerce involving searching for and selecting goods for purchase, making payments online for those goods, and rating goods and their distributors. Not common is the use of these technologies for commerce involving real-time knowledge sharing services with in-system payments for those services when so required. Existing services for finding and engaging knowledge providers online typically involve unpaid services also known as free services or volunteer services.

Additionally, peer-to-peer network topologies support node-to-node direct texting, audio telecommunications, video-chat and multimedia that are facilitated by means of the Internet, wireless-fidelity also known as wifi, and cellular phone communications systems. These telecommunication technologies are commonly used for information exchanges but without in-system capabilities for the payment of fees for the services representing the time and talent of the knowledge provider in situations where providers require payment for their services as knowledge providers.

### BRIEF SUMMARY OF THE INVENTION

The present invention is a system that establishes a value that can be expressed mathematically to represent the summation of relevant attributes of the knowledge Provider (P) and similarly establishes a value that can be mathematically expressed to represent the summation of relevant attributes of the knowledge Consumer (C) also known as a knowledge seeker with the differentiation that the Consumer is now consuming knowledge instead of seeking a source for knowledge. These summary values for P reflect a compilation of variables comprising knowledgeability, experience, education, prior ratings and reviews, etc. as well as subject-specific variables such as directly relevant experience, degrees and certifications and licenses applicable to the subject, seasonality if appropriate, geolocation if appropriate, etc.

The system facilitates matching C with P for the purpose of scheduling an immediate or future session, as well as session health issues including session breaks for the participants who experience declining performance as determined by recent trends in post-session performance ratings. The system includes “rewards” for system-defined desired behaviors including frequency of Facebook postings, Tweets, and other forms of social media sharing, as well as rewards for individuals who perform system-defined activities such as moderating certain forums, reviewing and mediating complaints, serving as online docents, and serving as help-desk volunteers. As a result of these and other valued activities, volunteers who serve the membership network gain higher rankings as Providers and enhanced member privileges as Consumers.

The primary algorithmic relationship is U=P−C where U comprises Uncertainty of a match, P comprises the Provider attributes, and C comprises the Consumer attributes. In this patent application, the relationships are referenced as algorithmic but these relationships can also be implemented using rule-based strategies, as well as data-filter strategies.

The present invention includes the secondary hierarchy of algorithms that define P, C and U. The secondary algorithms have varying numbers of terms.

At the time the system is introduced to a community or communities of knowledge seekers, knowledge consumers, and knowledge providers, the quantity and quality of information about providers will be greater than that of seekers or consumers in that the information about providers must be sufficient and necessary for them to promote their skills and knowledge and availability to give or sell or trade their time in knowledge sharing sessions. To minimize the barrier to growth of the community or communities utilizing the system, knowledge seekers who are newly enrolled in a network or social media utilizing the system are required to provide minimal information, for example, their self-reported name, email address and date of birth for future identity verification. Thus, in the initial growth of a community served by the system, more information about Providers is known than information about Consumers, which can be expressed as follows: data regarding P>data regarding C, with varying Uncertainty about the likelihood of a specific match leading to a successful session outcome, as quantifiable by post-session reviews, ratings, and reports. Over time, some or many Providers can be expected to also become Consumers, and some or many Consumers also can be expected to act sometimes as Providers with the result that more information will become known about Consumers based on their cumulative Consumer ratings and review, and the additional information they need to add to their in-system profiles in order to become Providers. As more information is known about Consumers, there is a directly corresponding decrease in Uncertainty about their matchability with Providers in order to produce favorable outcomes that are quantified by post-session reviews, ratings, and reports. In summary, the system changes over time to reflect reduced Uncertainty in matching all parties interested in ad hoc or scheduled sessions for the purpose of knowledge transfer.

The system is equally useful for sessions conducted at the same-geolocation and at distances such that the sessions require the use of smart mobile devices and also non-mobile devices that can access internet websites that serve information in support of the matching algorithm system. The immediate application of the system is using a website and a software application also called an app for smart mobile devices.

The system can also be used in face-to-face in-person knowledge transfer sessions, where the functions provided by the system comprise discovery platforms for knowledge seekers to find knowledge providers, scheduling and calendaring the knowledge transfer session, timing and if applicable metering the session and if applicable payment transaction processing, and post-session rating and reviewing activities, after the parties have met face-to-face in-person for the duration of the session of knowledge transfer.

An embodiment of the system is the use of Artificial Intelligence (AI) through a device, technology or cloud that functions as a knowledge provider to natural-person human knowledge consumers. A related embodiment of the system is the use of Artificial Intelligence (AI) through a device, technology or cloud that functions as a knowledge seeker and knowledge consumer with natural-person human knowledge providers, as would be the case wherein AI conducts polls and surveys and assessments of natural persons with skills and knowledge in subjects of interest.

An embodiment of the system is to embed some or all of the system into firmware, for example, producing a “feature phone” or “feature tablet” that facilitates better integration with the operating system (OS) and hardware of the device to support faster processing, better integration with third-party multimedia products/services, and other performance advantages such as the ability to download and access client-resident substantial libraries of knowledge providers in a subject or subjects of interest, for example, subjects in the categories of investments, business, sports, talent recruitment, technology, science, art, health, faith, relationships, self-betterment, and other subject-matter categories supported by communities of knowledge providers.

An embodiment of the system is to embed some or all of the system into firmware that can be used in devices that communicate with and interact with sensors, switches, artificial intelligence, and humans responsible for the management of such systems and networks.

It is an object of the present invention to provide a system for matching candidate knowledge seekers with candidate knowledge providers with a significant degree of matching efficiency, in order to achieve greater likelihood and degree of successful knowledge-sharing session outcomes as measurable by post-session ratings, reviews, and reports.

### BRIEF DESCRIPTION OF THE DRAWINGS

The present invention will be described by way of exemplary embodiments, but not limitations, illustrated in the accompanying drawings in which like references denote similar elements and in which:

FIG. 1 illustrates a representative mobile device app utilizing the present invention wherein knowledge providers are invited to sell or give knowledge, and knowledge seekers are solicited to buy knowledge or accept the gift of free knowledge.

FIG. 2 illustrates a sample app screen for a first-time user of the system to enter minimal information as might a knowledge seeker in order to search for one or more knowledge providers in a subject of interest.

FIG. 3 illustrates a representative search-results app screen for a subject defined through search terms, where the search results include a knowledge provider seeking payment by the minute for knowledge-sharing session of unspecified duration, another knowledge provider is offering services for a fixed-fee for a fixed-time session, and another knowledge provider is offering free services, and where all three providers display cumulative ratings scores for the subject of interest and cumulative ratings scores for all subjects, and the knowledge seeker can access reviews of prior performance by a provider wherein previous knowledge consumers offer text and/or audio and/or video reviews of the consumers' experience with the knowledge provider.

FIG. 4 illustrates a scheduling app screen with designated dates of availability for the knowledge seeker to make an appointment for a knowledge sharing or transfer session with a knowledge provider.

FIG. 5 illustrates a session app screen the knowledge provider's image and the knowledge consumer's image representing the real-time two-way video-communications, and with onscreen display of the other party's name, duration of the session thus far, the billing basis, and a clickable button to end to the session.

FIG. 6 illustrates a post-session ratings app screen that also enables the creation of a text-review, audio review, and/or video review of the session and the other party's performance and contribution, and provides an opportunity to report a problem and submit the review or reviews.

FIG. 7 illustrates simplified flow diagram of the process depicted in FIG. 1 through FIG. 6, including post-session feedback to the algorithmic matching system, and the capability for payment transactions in support of fee-based sessions.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

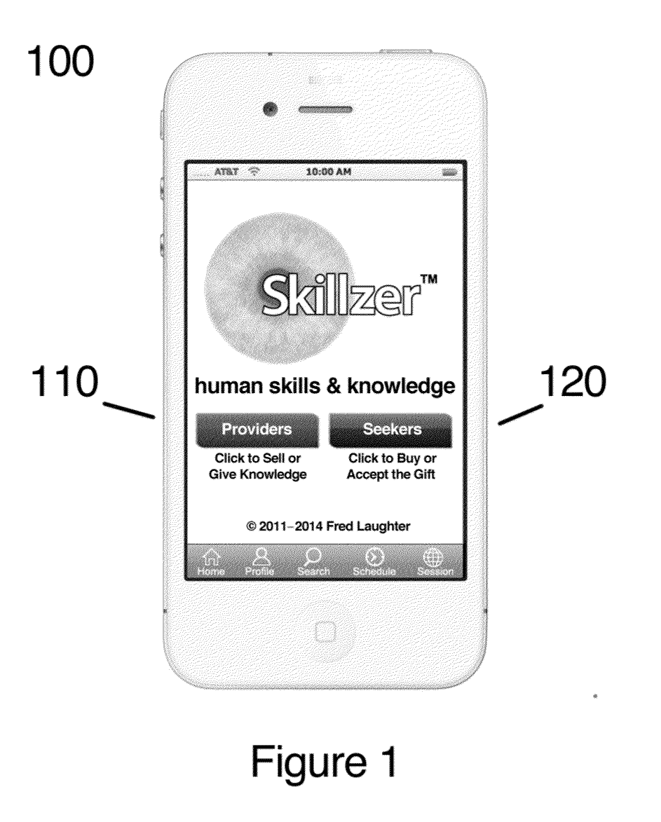

FIG. 1 depicts the graphic user interface (GUI) of a smart cellphone or similar mobile device displaying an opening app screen (100) such that the application or app incorporates the matching algorithm invention. This screen facilitates the participation of knowledge providers (110) who want to sell or give knowledge. This screen facilitates the participation of knowledge seekers (120), also known as consumers, who want to receive knowledge either through purchasing expert advice or by accepting the gift of knowledge offered by the participating provider without charge, also known as pro bono.

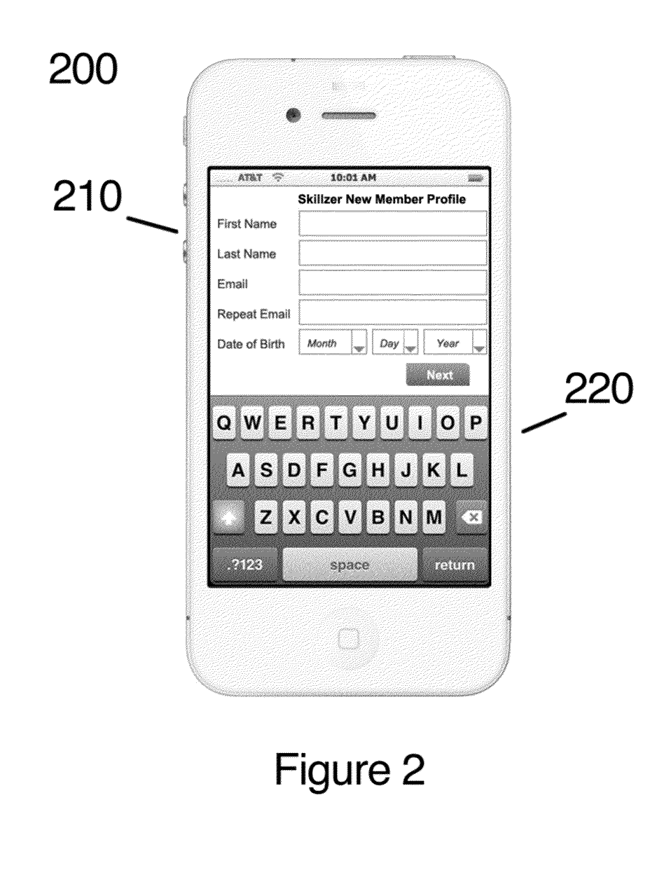

FIG. 2 shows a new member sign-up screen (200) on a smartphone app that utilizes the matching algorithm invention. A seeker (aka candidate consumer) who wants knowledge without payment (also known as pro bono) provides minimal information (210) with data input using the onscreen keyboard (220) of the smart mobile device. An information provider would be required to provide additional information about the provider's education, training, background, summary employment history, subjects in which the provider has or claims knowledge, relevant experience, and other factors that establish the credibility of the knowledge provider in a specific subject. The matching algorithm invention matches knowledge consumers about whom relatively little is known based on limited self-reporting, with qualified knowledge providers about whom more is known based on extensive self-reporting.

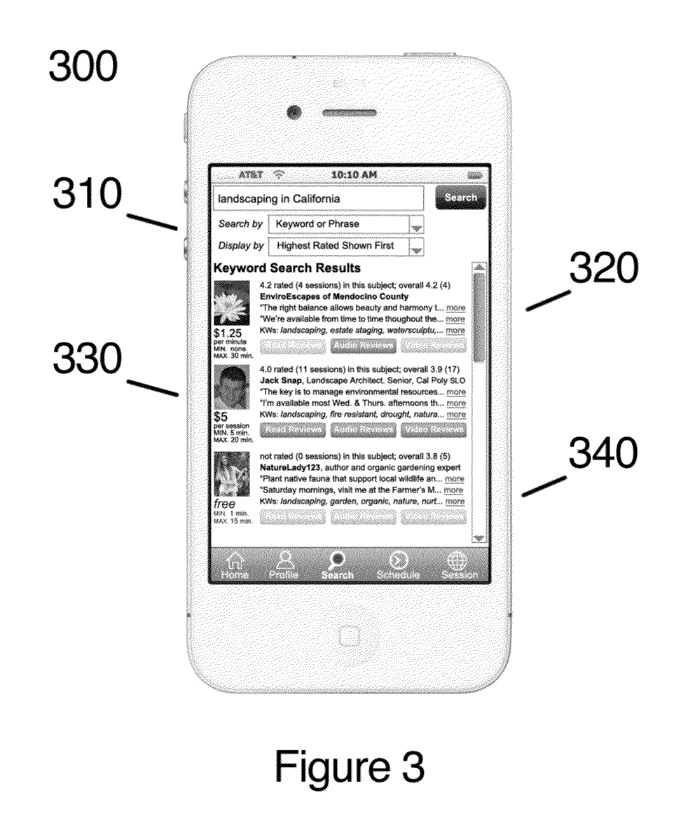

FIG. 3 shows a representative app screen (300) with matching results. In this example, the seeker/consumer has searched for knowledge providers in the subject of “landscaping in California” (310) based on keyword or phrase with search results displayed with highest rated matches shown first. In this example, the results include three search results. The first search result (320) represents a hypothetical business entity named EnviroEscapes of Mendocino County with a rating of 4.2 on a 5.0 scale, based on four prior sessions as a paid provider on this subject, where the provider charges $1.25 per minute with no minimum time limit and a 30-minute maximum time limit. The first search result match includes an “Audio Reviews” display that indicates that there are one or more audio reviews, also known as recorded voice reviews, by consumers who participated in prior sessions with this knowledge provider.

In FIG. 3, the second listed match result (330) for “landscaping in California” is a hypothetical college student who is a senior majoring in landscape architecture. The student in this example charges a flat rate of $5 for a session lasting 5 minutes to 20 minutes, and the student has 4.0 rating on a 5.0 scale in this subject based on 11 prior paid sessions, as well as having an overall rating of 3.9 on a 5.0 scale on all subjects in this example reflecting 17 prior sessions. The second search result match indicates that there are “Read Reviews” of text-based evaluations, and “Audio Reviews” of recorded-voice evaluations, and “Video Reviews” of video recordings by participants in previous knowledge transfer sessions to which this candidate provider was a party.

In FIG. 3, the third listed match result (340) represents a candidate knowledge provider who is unrated, with no prior sessions, no reviews via text or audio or video, and who is willing to provide unpaid (“free”) knowledge sharing.

In FIG. 3, the matching algorithm invention provides ranking that includes a mix of a pay-per-minute knowledge-provider (represented by 320), a pay-per-session knowledge provider (330), and an unpaid volunteer knowledge provider (340).

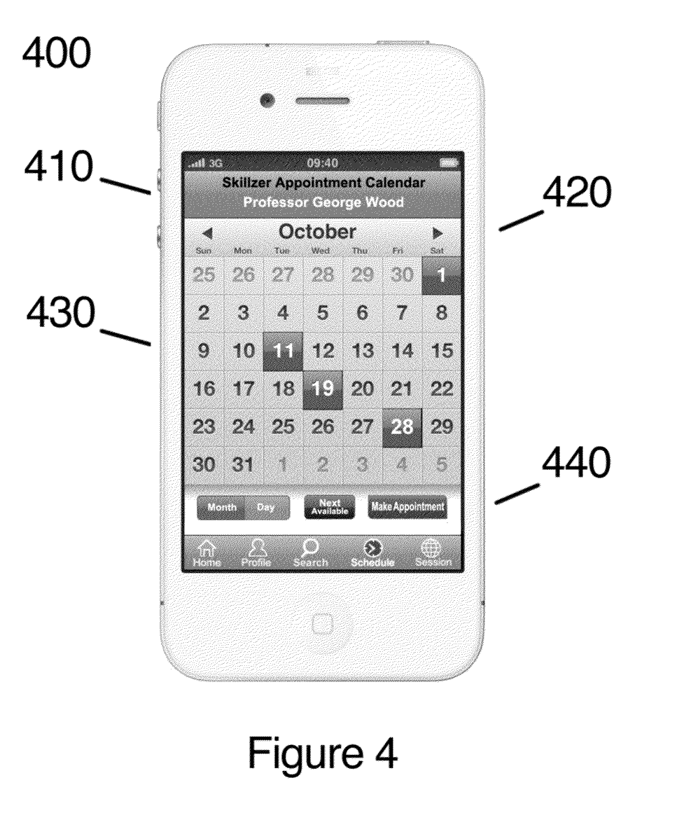

FIG. 4 represents the appointment calendar app screen (400). In this example, the candidate knowledge provider is “Professor George Wood” (410). The month displayed on the appointment calendar is “October” (420) and the app user can scroll using left-arrows and right-arrows to select other months. The days on which the candidate knowledge provider is available are represented by calendar dates (examples, “1” or “11” or “19” or “28”) that are highlighted by the onscreen app. The app user can select a date, then click “Make Appointment” (440) to designate a specific time on the selected date for a future appointment for knowledge transfer.

The matching algorithm invention incorporates “availability” information about knowledge providers for ad hoc immediate sessions for knowledge transfer, and future appointment dates and times as determined by the stated schedule of availability for future appointments with a knowledge provider.

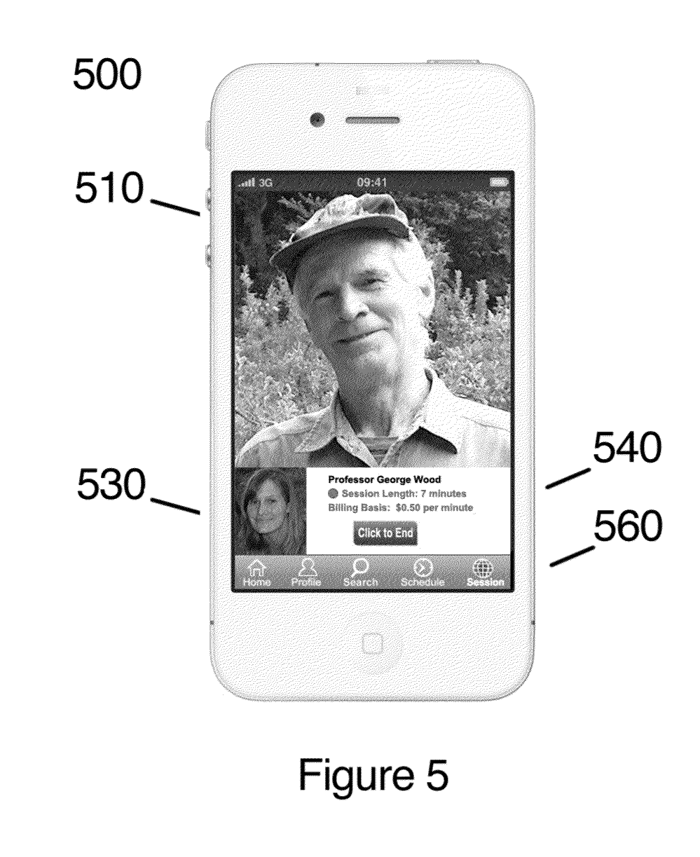

FIG. 5 depicts a knowledge transfer session (500) using videoconferencing, also known as video-chat, via a smart mobile device in this example. The screen shown in FIG. 5 represents the view on the device of the knowledge seeker, also known as the consumer. In FIG. 5, the knowledge provider (510) is shown in a larger format than the image of the knowledge consumer (530) because this screen depicts the consumer's view. This screen design shows information (540) about this knowledge sharing session, in this example indicating the name of the knowledge-provider (“Professor George Wood”), the session duration thus far (“7 minutes”) and the billing basis (“$0.50 per minute”). The screen also indicates at the bottom of the screen (560) that a “Session” is in progress as indicated by the session-icon and session-word being emboldened in comparison to other iconic representations of app modes (“Home,” “Profile,” “Search,” and “Schedule”).

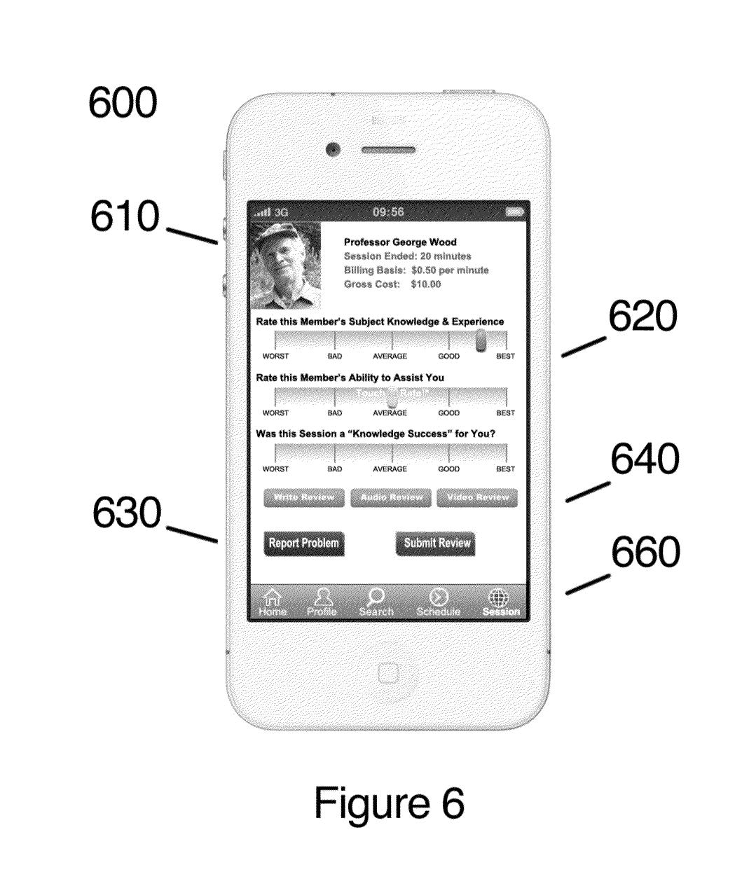

FIG. 6 shows a post-session ratings screen (600), in this example wherein the knowledge consumer is rating the knowledge provider. The provider in this example (610) is “Professor George Wood” who has completed a “20-minute session” for a total of “$10.00” in payment. In this example, the evaluating knowledge-consumer is provided with three statements (620) for touch-screen ratings represented by “worst” to “best” with opportunities for partial or full increments on the sliding scale. The data obtained from the three ratings (“knowledge,” “ability to assist,” and “knowledge session success”) are added to the cumulative ratings score of the knowledge provider. The aforementioned cumulative ratings scores are factors in the matching algorithm invention, along with other factors that are included in the matching algorithm invention. At the end of each session, whether free or involving payment for services, the knowledge consumer rates the provider (610) and the knowledge provider similarly rates the knowledge consumer. Using this or a comparable post-session screen, the evaluator can record a review (640) by text, audio recording, or video recording as part of this post-session mode (660). This example screen also provides a button to “Report Problem” (630) that is the vehicle for filing a complaint against the other party, where complaints are recorded and included in matching algorithm invention.

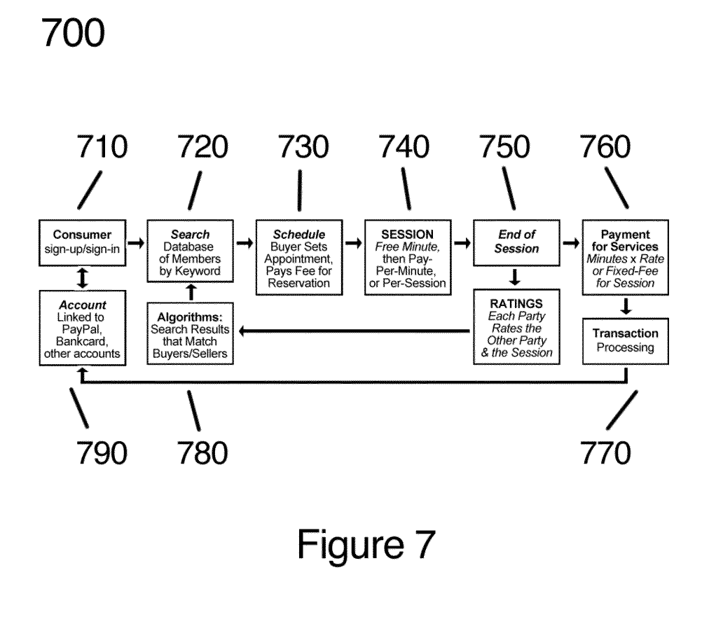

FIG. 7 is a summary flow chart (700) of the major steps involved in the process of discovery, search, scheduling, engaging in a session and post-session ratings, with mechanisms for feedback to the matching algorithm invention and for payment calculation and transaction processing for sessions involving payment. When an individual first logs-on (710) to the app or to the website, the consumer is required to enroll, also known as sign-up, or to sign-in if he or she already has an account. After signing-in, the consumer can search (720) the database of members by keywords or phrases or by category or subject area. After selecting a knowledge provider, the knowledge seeker may schedule (730) a future appointment in the event that the desired candidate knowledge provider is not available immediately for an ad hoc session. In the case of paid knowledge providers, a deposit may be required to encourage knowledge seekers to keep their appointments. The actual session (740) may be free or a fee-based, but in any case the first minute is without charge so that the parties can establish that they can acceptably see and hear each other, and exchange greetings and salutations. At the end of each session (750), each party participates in ratings and reviews that are incorporated in the algorithmic matching (780) for future knowledge-transfer sessions. For sessions involving payment (760), the system calculates payments, processes the transactions (770) and issues payment (790) via PayPal, bankcard, or using other means such as Bitcoin, Ripple XRP, and other math-based digital currencies.

The present invention is a matching algorithm system that comprises an equation for quantifiably determining the Uncertainty (U) associated with the measurable outcome of matching a Knowledge Consumer (C) with a Knowledge Provider (P) for a knowledge transfer or knowledge sharing session at the mutual convenience of the participating parties.

The primary matching algorithms comprise the following:

U=P−C Algorithm 1

P=C+U Algorithm 2

C=P−U Algorithm 3
where
   P is the Provider of knowledge
   C is the Consumer of knowledge
   U is the Uncertainty of the outcome of a match

The secondary matching algorithms comprise:

P=P_{Δ}[Q+(Pᵣ/P_{C}+P_{P})]+MZ[(AKN)/F+(X$)+(T+G+L+E)] Algorithm 4
where Example range of units:

| | |
|---|---|
| A = Availability | 0 to 5 |
| E = Educator or trainer experience | 1 to 5 |
| F = Session fatigue, session health | 1 to 5 |
| G = Geolocation related to subject of interest | 1 to 5 |
| K = Keyword and key-phrase matching | 5 to 50 |
| L = Licensing, certifications | 5 to 50 |
| M = Communications, social media sharing | to 75 |
| P_{Δ}= Provider performance trending | 1 to 5 |
| Pᵣ = Provider rating | 1 to 5 |
| P_{C} = Complaints against this Provider | 1 to 5 |
| P_{P} = Complaints by Provider against Consumer(s) | 1 to 5 |
| Q = Knowledgeability in subject of interest | 1 to 100 |
| N = Understandability, language and technical | 1 to 25 |
| T = Time, temporal considerations | 1 to 5 |
| X = Premium membership benefits | 5 to 50 |
| Z = Activity levels supporting system and network | 1 to 100 |
| $ = Payment ready (if fee-based) | 1 to 5 |

C=C_{Δ}(Q+Cᵣ/C_{C}+C_{P})+MZ[(AN)+(X$)] Algorithm 5
where Example range of units:

| | |
|---|---|
| A = Availability | 0 to 5 |
| C_{Δ}= Consumer Performance Trending | 1 to 5 |
| Cᵣ = Consumer Rating | 1 to 5 |
| C_{C} = Complaints against this Consumer | 1 to 5 |
| C_{P} = Complaints by Consumer against Provider(s) | 1 to 5 |
| M = Communications, sharing on social media | 1 to 75 |
| Q = Knowledgeability in Subject of Interest | 1 to 100 |
| N = Understandability, language and technical | 1 to 25 |
| X = Premium membership benefits | 5 to 50 |
| Z = Activity levels supporting system and network | 1 to 100 |
| $ = Payment ready (if fee-based) | 1 to 5 |

U=U_{d}+Uₒ+U_{g}+Uₐ+Uₑ+Uᵣ+Uₘ+U_{b}+U_{L1}+U_{L2}+U_{L1}+U_{X} Algorithm 6
where
   U_{d}=unknown biases (±) reflecting other-party attitude, disposition, countenance
   Uₒ=unknown biases (±) reflecting other-party outward appearance
   U_{g}=unknown biases (±) reflecting other-party gender
   Uₐ=unknown biases (±) reflecting other-party age-appropriateness for subject, too youthful to too old
   Uₑ=unknown biases (±) reflecting other-party ethnicity, race, national origin
   Uᵣ=unknown biases (±) reflecting other-party religion or beliefs or presumed value system
   Uₘ=unknown biases (±) reflecting other-party mannerisms of speech, expression, and gesture
   U_{b}=unknown biases (±) reflecting other-party background images or setting (in a crowded and noisy location, etc.)
   U_{L1}=unknown biases (±) reflecting other-party language skills (ESL, distracting regional accent, etc.)
   U_{L2}=unknown biases (±) reflecting other-party technical language skills (technical vocabulary, etc.)
   U_{X}=unknown biases (±) with undefined associations

The primary source of knowledge provider-rendered information is self-reporting using online forms, supplemented with videos similar in format to dating-service or job-seeker short video-clips and/or supplemented with audio self-introductions. Additionally, participating members can provide non-session ratings and endorsements of other members for their expertise, personality, work ethic, achievements, etc.

A significant source of information about knowledge Providers and knowledge Consumers is cumulative statistical records of their activities, ratings given, ratings received, complaints given, complaints received, and Δ (delta) changes comprising ratings trends as improvement or decline determined by specified ratings changes (for example, ±10%) in a specified period of time (for example, trailing 30 days).

For premium membership levels, the system can verify education, certification, and licensing by checking databases online and through specific requests to the appropriate offices and agencies. The verifications can be performed by volunteers, compensated staff, and/or automated processes. Participants with premium membership levels may be granted preferential positioning in ranked results of knowledge Providers, and greater depth of choice as knowledge Consumers seeking the services of free or fee-based knowledge Providers.

The weighting of units for various terms and tertiary algorithms is adjustable to emphasize or de-emphasize various parameters. For example, the range of units for a specific term (for example, 1-to-5 units) can be adjusted readily to fit the requirements of specific applications involving varying communities of participants and operational objectives of system operators such as businesses and other organizations. For example, if an objective is to rapidly expand the community of participants in a social network utilizing the matching algorithm system, the range of units for social media communications could be quantitatively increased, for example from 10-to-25 units to instead 1-to-100 units; and if the objective were to reduce the incentives and rewards for social media sharing, the range of units could be reduced from 1-to-100 units to instead 1-to-5 units, for example.

Supporting the terms of the primary and secondary algorithms are additional terms and tertiary algorithms comprising the following:

### A=Availability

A=Aₙ+(A_{w}A_{d}) Algorithm 7

where
Aₙ=Provider is available now for ad hoc session
A_{w}=Availability window for scheduled future session, for example, open appointment opportunity in the schedule(s), for example, within next 72 hours or 15 days as examples
A_{d}=Diligence in that Provider recently has interacted with appointment calendar within a defined time frame, for example, within an immediately prior time frame≦A_{w}

### C_{Δ}=Consumer Performance Trending

C_{Δ}=(C_{Δ%1}+C_{ΔT3})+(C_{Δ%2}+C_{ΔT2})+(C_{Δ%3}+C_{ΔT1}) Algorithm 8

where
C_{Δ%1}=percentage increase (+) or decrease (−) in Consumer's ratings, as a percentage change within system-defined parameters, for example, ±10%
C_{Δ%2}=percentage increase (+) or decrease (−) in Consumer's ratings, as a percentage change within alternative system-defined parameters, for example, ±15%
C_{Δ%3}=percentage increase (+) or decrease (−) in Consumer's ratings, as a percentage change within system-defined parameters, for example, ±20%
C_{ΔT1}=change in performance within a defined timeframe, for example, trailing 24 hours
C_{ΔT2}=change in performance within a defined timeframe, for example, trailing 5 days
C_{ΔT3}=change in performance within a defined timeframe, for example, trailing 30 days

### Cᵣ=Consumer Rating

Cᵣ=Cᵣₓ+Cᵣₐ Algorithm 9

where
Cᵣₓ=cumulative Consumer rating by Providers in sessions for specified subject
Cᵣₐ=cumulative Consumer rating by Providers in sessions for all subjects
   C_{C}=Complaints against Consumer

C_{C}=C_{Cx}+C_{Ca} Algorithm 10

where
C_{Cx}=cumulative Consumer complaints by Providers in sessions for specified subject
C_{Ca}=cumulative Consumer complaints Providers in sessions for all subjects
   C_{P}=Complaints by Consumer against Provider(s)

C_{P}=C_{Px}+C_{Pa} Algorithm 11

where
C_{Px}=cumulative Consumer complaints against Providers for specified subject
C_{Pa}=cumulative Consumer complaints against Providers for all subjects

### E=Educator or Trainer Experience

E=E₁+E₂+E₃ Algorithm 12

where
E₁=Educator (active or retired) in college or university, from teaching assistant to professor
E₂=Educator (active or retired) in primary or secondary school, public or private
E₃=Professional trainer providing corporate, compliance, sales, technical training

### F=Session Fatigue, Session Health

F=F₁+F₂+F₃ Algorithm 13

where
F₁=Participant is given a mandatory mental-acuity-refreshment break, for example, 2-minute break, after a defined concentration of events, for example, ≧3 sessions, in ≦30 minutes.
F₂=Participant is given a mandatory 3.5-minute break, for example, after a session with duration of ≧45 minutes.

F₃=Participant with outlier datapoint in both most-recent post-session ratings given and post-session rating received, with reduced ratings represented with a higher value in the range of values for this term and increased ratings represented with a lower value in the range of values for this term.

G=Geolocation related to Subject of Interest

G=Gₚ+Gₓ Algorithm 14

where
Gₚ=Geoproximity (local vs. distal), categorically suitable for certain subjects, for example, travel, culture, localized history, and hospitality industry locations.
Gₓ=Geoexclusivity, for Providers seeking to provide services to Consumers not in the Providers' local market, for example, shop owners providing knowledge about business and marketing with willingness only in providing that knowledge to persons unlikely to compete for business in the markets of interest to the Provider.

### K=Keyword and Key-phrase Matching

K=K_{Mm}+(K_{M1}+K_{M2}+K_{M3}) Algorithm 15

where
K_{Mm}=product of Keyword and Key-phrase matches requested by Consumer
K_{M1}=exact match of the keyphrase in search query used by Consumer
K_{M2}=exact match of at least one keyword in search query used by Consumer
K_{M3}=near match, for example, food and cuisine

### L=Licensing, Certification in Professions and Trades

L=Lₙ₁+Lₙ₂+Lₙ₃ Algorithm 16

where
Lₙ₁=first level of licensing and certification and position for the subject of interest
Lₙ₂=second level of licensing and certification and position for the subject of interest
Lₙ₃=third level of licensing and certification and position for the subject of interest
   Representative examples comprising select professions and trades:
L_{H1}=Health, Provider is MD, ND, CD, PhD in health sciences, CDC employee
L_{H2}=Health, Provider is PA, RN, LPN, midwife
L_{H3}=Health, Provider is care manager, case manager, etc.
L_{F1}=Finance, Provider is ChFC, CFP, etc.
L_{F2}=Finance, Provider is govt.-regulated broker/dealer, insurance agent, etc.
L_{F3}=Finance, Provider is private fiduciary, etc.
L_{L1}=Legal, Provider is Attorney in bar association of applicable jurisdiction
L_{L2}=Legal, Provider is paralegal, etc.
L_{L3}=Legal, Provider is a judiciary employee, retired jurist in applicable jurisdiction, etc.

L_{E1}=Engineering, Provider is deg reed engineer with professional association
L_{S1}=Sports, Provider is professional (active or retired) coach or player
L_{S2}=Sports, Provider is secondary or college-level (active or retired) coach or player
L_{S3}=Sports, Provider is amateur coach or player, sports fan, fantasy sport enthusiast

### M=Communications, Sharing on Social Media

M=+Mᵢ+Mₓ+Mₑ+M_{f}+M₁+M₂+Mₙ Algorithm 17

where
Mᵢ=Internal to the system, using messaging, number of communications sent
Mₓ=Txt, number of messages sent from system
M_{w}=Tweets, number of Tweets sent from system
Mₑ=Email, number of emails sent from system
M_{f}=Facebook posts from system
M₁=communicated using additional channel #1
M₂=communicate using additional channel #2
Mₙ=communicated using additional channel n.

### P_{Δ}=Provider Performance Trending

P_{Δ}=(P_{Δ%1}+P_{ΔT3})+(P_{Δ%2}+P_{ΔT2})+(P_{Δ%3}+P_{ΔT1}) Algorithm 18

where
P_{Δ%1}=percentage increase (+) or decrease (−) in Provider's ratings, as a percentage change within system-defined parameters, for example, ±10%
P_{Δ%2}=percentage increase (+) or decrease (−) in Provider's ratings, as a percentage change within system-defined parameters, for example, ±15%
P_{Δ%3}=percentage increase (+) or decrease (−) in Provider's ratings, as a percentage change within system-defined parameters, for example, ±20%
P_{ΔT1}=change in performance within a defined timeframe, for example, trailing 24 hours
P_{ΔT2}=change in performance within a defined timeframe, for example, trailing 5 days
P_{ΔT3}=change in performance within a defined timeframe, for example, trailing 30 days

### Pᵣ=Provider Rating

Pᵣ=Pᵣₓ+Pᵣₐ Algorithm 19

where
Pᵣₓ=cumulative Provider rating by Consumers in sessions for specified subject
Pᵣₐ=cumulative Provider rating by Consumers in sessions for all subjects
   P_{C}=Complaints against Provider

P_{C}=P_{Cx}+P_{Ca} Algorithm 20

where
P_{Cx}=cumulative Provider complaints by Consumers in sessions for specified subject
P_{Ca}=cumulative Provider complaints by Consumers in sessions for all subjects
   P_{P}=Complaints by Consumer against Provider(s)

P_{P}=P_{Px}+P_{Pa} Algorithm 21

where
C_{Px}=cumulative Provider complaints against Consumers for specified subject
C_{Pa}=cumulative Provider complaints against Consumers for all subjects

### Q=Knowledgeability in Subject of Interest

Q=Q₁ (for Consumers) Algorithm 22

Q=Q₁+Qₑ+Q_{w}+Q_{T1}+Q_{T2}+Q_{T3}+Qᵥ+Q_{g}+Qₐ (for Providers) Algorithm 23

where
Q₁=Knowledgeability as determined by participant self-assessment
Qₑ=Knowledgeability based on academic and formal training, including degrees earned and progress toward earning degrees
Q_{w}=Knowledgeability based on honors and awards in the subject or a related subject
Q_{T1}=Knowledgeability based on time active in the subject measured in cumulative hours, for example, incremental values in units representing ≦1 hour to ≧5,000 hours where 5,000 hours is presumed to depict mastery of the subject through experience
Q_{T2}=Knowledgeability based on time active in the subject measured since initiation of interest in the subject, for example, measured in time elapsed since first efforts
Q_{T3}=Knowledgeability based on time active in subject areas affiliated and associable with the specific subject of interest, measured in cumulative hours, for example, incremental values in units representing ≦1 hour to ≧10,000 hours
Qᵥ=Knowledgeability based on visibility and prominence in the field, quantified to include past and present employment, nature and number of citations in the literature and in various media, curriculum vita publications to date if applicable, and related factors.
Q_{g}=Gender match of Provider and Consumer, for specified subjects
Qₐ=Age parameters of Provider [young≦P≦old], for specified subjects

### N=Understandability, Natural Language and Technical Language

N=NₙNₜ Algorithm 24

where
Nₙ=natural language proficiency, for example, English as Second Language (ESL)
Nₜ=technical language proficiency, for example, the vocabulary for specific technologies and fields of science and for select professions and trades

### T=Time, Temporal Considerations

T=T_{C}(T_{P1}+T_{P2}+T_{P3}+T_{P4}) Algorithm 25

where
T_{C}=Consumer time and day patterns corresponding to optimal ratings by Consumer of Providers
T_{P1}=Provider mean duration of sessions matched with Consumer mean duration of sessions, for example, long-winded chatty participants are matched, and short-duration question-and-answer participants are matched.
T_{P2}=Provider local time-of-day pattern of service provision, for example, for session scheduling
T_{P3}=Provider local time-of-day pattern of service provision in sessions that are post-session rated above the mean rating of Provider, for example, representing the better time of day in pursuit of more highly rated performance
T_{P4}=Provider local time-of-day pattern of service provision in sessions that are post-session rated in the top quartile of ratings of Provider, for example, representing the best time of day for more highly rated performance

### X=Premium Membership Benefits

X=X_{P1}+X_{P2}+X_{P3}+X_{C1}+X_{C2}+X_{C3} Algorithm 26

where
X_{P1}=Provider is Gold level of Membership, with superior ranking privilege
X_{P2}=Provider is Silver level of Membership, with preferential ranking
X_{P3}=Provider is Bronze level of Membership, with advantageous ranking
X_{C1}=Consumer is Gold level of Membership, with superior access to talent
X_{C2}=Consumer is Silver level of Membership, with preferential access to talent
X_{C3}=Consumer is Bronze level of Membership, with advantageous access to talent
In applications and utilization of the system where there are no membership benefits or premium membership benefits, X defaults to 1 and does not mathematically impact the algorithmic calculation. Also, the stated membership levels of Gold, Silver, and Bronze are provided only as illustrative of the concept and a path toward implementation.

### Z=Activity Levels Supporting the System and Network

Z=Z₁+Z₂+Z₃ Algorithm 27

where
Z₁=Activity Levels: Provider as Match Candidate for a Specific Session
Z₂=Activity Levels: Consumer as Match Candidate for a Specific Session
Z₃=Activity Levels: Individual Participation in Surveys, Online Polls, Forums, etc.

Z₁=Z_{1k%}(Z_{1$C}(Z_{1$C}/Z_{1$P})+(Z_{1#}/Z_{1#P})+(Z_{1T}/Z_{1TP})+(Z_{1%$}/Z_{1%}) Algorithm 28

where
Z_{1k%}=Time: % as Provider in the subject of interest vs. Total Time as Provider
Z_{1$C}=Total Fees Paid to Date for Sessions when this Provider is a Consumer, for example, in U.S. Dollars also known as USD and other fiat-currencies and one or more digital currencies
Z_{1$P}=Total Fees Charged to Date for Fee-based Sessions, for example, in U.S. Dollars also known as USD and other fiat-currencies and one or more digital currencies
Z_{1#}=Number of Sessions Cumulative as Provider and Seeker also known as Consumer
Z_{1#P}=Number of Sessions as Provider
Z_{1T}=Time: Total Both as Provider and Seeker and Consumer
Z_{1TP}=Time: Total as Provider
Z_{1%}=Time: % as Provider vs. Total Time as Provider and Seeker also known as Consumer
Z_{1%$}=Time: % as Paid Provider vs. Total Time as Provider

Z₂=Z_{2k%}(Z_{2$C}/Z_{2$P})+(Z_{2#}/Z_{2#P}) Algorithm 29

where
Z_{2k%}=Time: % as Seeker and Consumer utilizing this Keyword or Key-phrase or closely related Keyword or Key-phrase vs. Total Time as Seeker and Consumer
Z_{2$C}=Total Fees Paid to Date for Sessions when this Participant is a Consumer, for example, in U.S. Dollars also known as USD and other fiat-currencies and one or more digital currencies
Z_{2$P}=Total Fees Charged to Date for Fee-based Sessions when this Participant is a Provider, for example, in U.S. Dollars also known as USD and other fiat-currencies and one or more digital currencies
Z_{2#}=Number of Sessions Cumulative as Provider and Seeker also known as Consumer
Z_{2#P}=Number of Sessions when this Participant is a Provider

Z₃=Z₃ₛ+Z₃₀+Z_{3f}+Z₃ₚ+Z₃ₓ+Z_{3z} Algorithm 30

where
Z₃ₛ=Participation in Surveys, Online Polls, etc.
Z₃ₒ=Other Self-Managed Activities for Documenting Opinions and Preferences
Z_{3f}=Forum Participation
Z₃ₚ=Postings, other than Forums, to comprise Comments and Similar Postings
Z₃ₓ=Profile Expansion
Z_{3z}=Volunteer Services to other participants: comprising help desk support on how to use the system, online docent for giving virtual tours to individuals and groups, and other activities that benefit the system and the communities that use the system.

### $=Payment Ready

If fee-based session where Knowledge Provider requires payment:

$=$_{Pa}+$_{Ca}+$_{CF} Algorithm 31

where
$_{Pa}=Provider has at least one suitable account for effecting a transfer from Consumer
$_{Ca}=Consumer has at least one suitable account for effecting a transfer to the Provider
$_{CF}=Consumer has necessary and sufficient funds in the suitable account where amount of funds≧scheduled timed-session fees (for example, $25 for 15 minutes) or where amount of funds≧twice mean anticipated Provider fees based on per-minute fees times Provider's average session length
   In summary, the categories of terms and their associated values comprise:

P is the Provider of Knowledge
where Provider Performance comprises:
   P_{Δ}=Provider Performance Trending
   Pᵣ=Provider Rating
   P_{C}=Complaints against Provider
   P_{P}=Complaints by Provider against Consumer(s)

C is the Consumer of Knowledge
where Consumer Performance comprises:
   C_{Δ}=Consumer Performance Trending
   Cᵣ=Consumer Rating
   C_{C}=Complaints against Consumer
   C_{P}=Complaints by Consumer against Provider(s)

Terms with Specificity to the Subject of Interest
K=Keyword and key-phrase matching
Q=Knowledgeability in Subject of Interest
E=Educator or trainer experience
L=Licensing, certification in professions and trades
N=Understandability, natural and technical language
T=Time, temporal considerations

Terms with Specificity to the Anticipated Session
A=Availability
$=Payment ready (if fee-based)
F=Session fatigue, session health

Terms with Specificity to Intended Incentives and Rewards for Participant Behaviors
M=Communications, sharing on social media
X=Premium membership benefits
Z=Activity levels supporting the system and network

The system utilizes these terms and their associated values in hierarchical algorithmic configurations to match Knowledge Providers, Knowledge Seekers, and Knowledge Consumers for the purpose of achieving favorable session outcomes as quantified by post-session ratings, reviews, and reports.

An alternative method and process to achieve the same or similar results is rule-based execution instead of algorithmic execution.

An alternative method and process to achieve the same or similar results is the extensive use of data filters and filters for methods and processes instead of algorithmic execution. Those filters could be rule-based or an implemented or implementable application of artificial intelligence (AI).

The range of units for each term is adaptable to the requirements of those using the system.

The system anticipates that knowledge providers will post relatively brief videos, audio files, and multimedia that promote their expertise, for example, streaming or downloadable videos corresponding to frequently asked questions in a subject or field of interest. The intended use of the system is to facilitate knowledge transfer sessions for real-time interaction between and among participants where real-time means that both or all parties share a common experience in a factual time frame and occurring for all parties simultaneously and contemporaneously.

The present invention is a system for human skills and knowledge sharing between one or more knowledge providers and one or more knowledge seekers, comprising:
means for logging into a system for human skills and knowledge sharing between the one or more knowledge providers and the one or more knowledge seekers;
means for searching the system for human skills and knowledge sharing between the one or more knowledge providers and the one or more knowledge seekers for the one or more knowledge providers;
means for selecting the one or more knowledge providers;
means for scheduling an appointment with the one or more knowledge providers;
means for conducting the appointment with the one or more knowledge providers;
means for rating and reviewing the session and one or more other session participant where all participating one or more knowledge seekers and all participating one or more knowledge providers rate and review the session and one or more other parties to the session; and
means for paying the one or more knowledge providers the session service of knowledge sharing, if payment is required by the one or more knowledge providers.

The present invention is a system for human skills and knowledge sharing between one or more knowledge providers and one or more knowledge seekers, comprising:
a hybrid network topology with client-server centralized discovery and knowledge-sharing session-scheduling functions, and peer-to-peer functions for multimedia knowledge-sharing sessions, such that the network topology comprises one or more centralized servers with one or more clients, the one or more centralized servers each include a processor system, a communications interface, a communications system, an input system and an output system, the server system having access to the network, wherein the one or more centralized servers are utilized by the one or more knowledge providers wherein one or more client-nodes function as peer-to-peer nodes during one or more real-time single-media, multimedia and videoconferencing knowledge-sharing sessions;
a memory system residing on each of the server systems, the memory system having an operating system, a communications module, a web browser module, a web server application and a human skills and knowledge sharing non-transitory storage media; and
a website having a plurality of web pages, the web pages reside on the human skills and knowledge sharing non-transitory storage media.

The present invention is a system for human skills and knowledge sharing between one or more knowledge providers and one or more knowledge seekers, wherein the topology network includes client-server functions and peer-to-peer functions.

The present invention is a system for human skills and knowledge sharing between one or more knowledge providers and one or more knowledge seekers, wherein the client includes an output system, an input system, a memory system, a processor system and a communications system.

The present invention is a system for human skills and knowledge sharing between one or more knowledge providers and one or more knowledge seekers, wherein the client is a mobile wireless computing device or a non-mobile wired computer device with sufficient bandwidth during multimedia video conferencing.

The present invention is a system for human skills and knowledge sharing between one or more knowledge providers and one or more knowledge seekers, wherein the client is a mobile phone or mobile tablet device with an operating system and broadband capability.

The present invention is a system for human skills and knowledge sharing between one or more knowledge providers and one or more knowledge seekers, wherein the mobile phone with an operating system utilizes a graphic user interface or a voice-controlled interface.

The present invention is a system for human skills and knowledge sharing between one or more knowledge providers and one or more knowledge seekers, wherein the client is utilized by the one or more knowledge seekers and by the one or more knowledge providers.

The present invention is a system for human skills and knowledge sharing between one or more knowledge providers and one or more knowledge seekers, wherein the client accesses the server system via the hybrid network topology comprising client-server functions and peer-to-peer functions.

The present invention is a system for human skills and knowledge sharing between one or more knowledge providers and one or more knowledge seekers, wherein the hybrid network topology is deployed or deployable on the Internet, wireless fidelity or a cellular telephone technology.

The present invention is a system for human skills and knowledge sharing between one or more knowledge providers and one or more knowledge seekers, wherein the client is a wireless mobile phone with an operating system network or a tablet device with an operating system network.

The present invention is a system for human skills and knowledge sharing between one or more knowledge providers and one or more knowledge seekers, wherein the human skills and knowledge sharing non-transitory storage media provides a new member sign-up screen.

The present invention is a system for human skills and knowledge sharing between one or more knowledge providers and one or more knowledge seekers, wherein the new member sign-up screen includes self-reported information about a new member that is incorporated in a member profile page of each of the one or more knowledge seekers and each of the one or more knowledge providers.

The present invention is a system for human skills and knowledge sharing between one or more knowledge providers and one or more knowledge seekers, wherein the new member sign-up screens provide information about each of the one or more knowledge providers that includes the one or more knowledge providers education, training, background and summary employment history, one or more subjects in which each of the one or more knowledge providers has or claims knowledge, relevant experience and one or more factors that establish credibility of the one or more knowledge providers in a specific subject.

The present invention is a system for human skills and knowledge sharing between one or more knowledge providers and one or more knowledge seekers, wherein the human skills and knowledge sharing non-transitory storage media provides a discovery platform to search and find the member profile information associated with one or more knowledge providers.

The present invention is a system for human skills and knowledge sharing between one or more knowledge providers and one or more knowledge seekers, further comprising one or more knowledge providers search-results screens that include one or more text reviews, one or more audio reviews and one or more video reviews.

The present invention is a system for human skills and knowledge sharing between one or more knowledge providers and one or more knowledge seekers, wherein the one or more knowledge providers search-results screen includes a ranking that includes a mix of one or more pay-per-minute knowledge-providers, one or more pay-per-session knowledge providers and one or more unpaid volunteer knowledge providers.

The present invention is a system for human skills and knowledge sharing between one or more knowledge providers and one or more knowledge seekers, wherein the one or more knowledge providers will pay participants to receive information.

The present invention is a system for human skills and knowledge sharing between one or more knowledge providers and one or more knowledge seekers, wherein the human skills and knowledge sharing non-transitory storage media provides an appointment calendar app screen to schedule a knowledge sharing session and functions to send pre-session reminders by email and texting to all participants in a scheduled knowledge sharing session.

The present invention is a system for human skills and knowledge sharing between one or more knowledge providers and one or more knowledge seekers, wherein the appointment calendar app screen includes a month with a plurality of days and a plurality of hours and fractions of hours representing the dates and times when the one or more knowledge providers are available to share real-time knowledge.

The present invention is a system for human skills and knowledge sharing between one or more knowledge providers and one or more knowledge seekers, wherein the appointment calendar app screen and reminder functions includes the one or more knowledge providers providing one or more ad hoc immediate sessions to transfer knowledge in real-time and future appointment dates and times as determined by a stated schedule of future appointment availability.

The present invention is a system for human skills and knowledge sharing between one or more knowledge providers and one or more knowledge seekers, wherein the human skills and knowledge sharing non-transitory storage media provides a knowledge transfer session screen utilizing video-conferencing, audio-conferencing, multimedia-conferencing and texting on the client.

The present invention is a system for human skills and knowledge sharing between one or more knowledge providers and one or more knowledge seekers, wherein the knowledge transfer session screen displays a name of the one or more knowledge providers, a session duration and a billing basis involving sessions requiring payment.

The present invention is a system for human skills and knowledge sharing between one or more knowledge providers and one or more knowledge seekers, wherein the knowledge transfer session screen displays if a session is in progress.

The present invention is a system for human skills and knowledge sharing between one or more knowledge providers and one or more knowledge seekers, wherein the human skills and knowledge sharing non-transitory storage media provides a post-session ratings screen.

The present invention is a system for human skills and knowledge sharing between one or more knowledge providers and one or more knowledge seekers, wherein the post-session ratings screen includes a rating from knowledge, ability to assist and knowledge session success.

The present invention is a system for human skills and knowledge sharing between one or more knowledge providers and one or more knowledge seekers, wherein the post-session ratings screen records a review by text, audio recording, or video recording as part of post-session mode.

The present invention is a system for human skills and knowledge sharing between one or more knowledge providers and one or more knowledge seekers, wherein the system for human skills and knowledge sharing between one or more knowledge providers and one or more knowledge seekers provides pro bono knowledge from the one or more knowledge providers to the one or more knowledge seekers.

The present invention is a method for human skills and knowledge sharing between one or more knowledge providers and one or more knowledge seekers, comprising the steps of:
logging into a system for human skills and knowledge sharing between the one or more knowledge providers and the one or more knowledge seekers;
searching the system for human skills and knowledge sharing between the one or more knowledge providers and the one or more knowledge seekers for the one or more knowledge providers;
selecting the one or more knowledge providers;
scheduling an appointment with the one or more knowledge providers;
conducting the appointment with the one or more knowledge providers;
rating and reviewing the session and one or more other session participants where all participating one or more knowledge seekers and all participating knowledge providers rate and review the session and one or more other parties to the session; and
paying the one or more knowledge providers the session service of knowledge sharing, if payment is required by the one or more knowledge providers.

1. A system for human skills and knowledge sharing between one or more knowledge providers and one or more knowledge seekers, comprising:
means for logging into a system for human skills and knowledge sharing between the one or more knowledge providers and the one or more knowledge seekers;
means for searching the system for human skills and knowledge sharing between the one or more knowledge providers and the one or more knowledge seekers for the one or more knowledge providers;
means for selecting the one or more knowledge providers;
means for scheduling an appointment with the one or more knowledge providers;
means for conducting the appointment with the one or more knowledge providers;
means for rating and reviewing the session and one or more other session participant where all participating one or more knowledge seekers and all participating one or more knowledge providers rate and review the session and one or more other parties to the session; and
means for paying the one or more knowledge providers the session service of knowledge sharing, if payment is required by the one or more knowledge providers.

2. A system for human skills and knowledge sharing between one or more knowledge providers and one or more knowledge seekers, comprising:
a hybrid network topology with client-server centralized discovery and knowledge-sharing session-scheduling functions, and peer-to-peer functions for multimedia knowledge-sharing sessions, such that the network topology comprises one or more centralized servers with one or more clients, the one or more centralized servers each include a processor system, a communications interface, a communications system, an input system and an output system, the server system having access to the network, wherein the one or more centralized servers are utilized by the one or more knowledge providers wherein one or more client-nodes function as peer-to-peer nodes during one or more real-time single-media, multimedia and videoconferencing knowledge-sharing sessions;
a memory system residing on each of the server systems, the memory system having an operating system, a communications module, a web browser module, a web server application and a human skills and knowledge sharing non-transitory storage media; and
a website having a plurality of web pages, the web pages reside on the human skills and knowledge sharing non-transitory storage media.

3. The system for human skills and knowledge sharing between one or more knowledge providers and one or more knowledge seekers according to claim 2, the topology network includes client-server functions and peer-to-peer functions.

4. The system for human skills and knowledge sharing between one or more knowledge providers and one or more knowledge seekers according to claim 2, wherein the client includes an output system, an input system, a memory system, a processor system and a communications system.

5. The system for human skills and knowledge sharing between one or more knowledge providers and one or more knowledge seekers according to claim 4, wherein the client is a mobile wireless computing device or a non-mobile wired computer device with sufficient bandwidth during multimedia video conferencing.

6. The system for human skills and knowledge sharing between one or more knowledge providers and one or more knowledge seekers according to claim 5, wherein the client is a mobile phone or mobile tablet device with an operating system and broadband capability.

7. The system for human skills and knowledge sharing between one or more knowledge providers and one or more knowledge seekers according to claim 6, wherein the mobile phone with an operating system utilizes a graphic user interface or a voice-controlled interface.

8. The system for human skills and knowledge sharing between one or more knowledge providers and one or more knowledge seekers according to claim 4, wherein the client is utilized by the one or more knowledge seekers and by the one or more knowledge providers.

9. The system for human skills and knowledge sharing between one or more knowledge providers and one or more knowledge seekers according to claim 4, wherein the client accesses the server system via the hybrid network topology comprising client-server and peer-to-peer functions.

10. The system for human skills and knowledge sharing between one or more knowledge providers and one or more knowledge seekers according to claim 9, wherein the hybrid network topology is deployed or deployable on the Internet, wireless fidelity or a cellular telephone technology.

11. The system for human skills and knowledge sharing between one or more knowledge providers and one or more knowledge seekers according to claim 4, wherein the client is a wireless mobile phone with an operating system network or a tablet device with an operating system network.

12. The system for human skills and knowledge sharing between one or more knowledge providers and one or more knowledge seekers according to claim 2, wherein the human skills and knowledge sharing non-transitory storage media provides a new member sign-up screen.

13. The system for human skills and knowledge sharing between one or more knowledge providers and one or more knowledge seekers according to claim 12, wherein the new member sign-up screen includes self-reported information about a new member that is incorporated in a member profile page of each of the one or more knowledge seekers and each of the one or more knowledge providers.

14. The system for human skills and knowledge sharing between one or more knowledge providers and one or more knowledge seekers according to claim 12, wherein the new member sign-up screens provide information about each of the one or more knowledge providers that includes the one or more knowledge providers education, training, background and summary employment history, one or more subjects in which each of the one or more knowledge providers has or claims knowledge, relevant experience and one or more factors that establish credibility of the one or more knowledge providers in a specific subject.

15. The system for human skills and knowledge sharing between one or more knowledge providers and one or more knowledge seekers according to claim 2, wherein the human skills and knowledge sharing non-transitory storage media provides a discovery platform to search and find the member profile information associated with one or more knowledge providers.

16. The system for human skills and knowledge sharing between one or more knowledge providers and one or more knowledge seekers according to claim 2, further comprising one or more knowledge providers search-results screens that include one or more text reviews, one or more audio reviews and one or more video reviews.

17. The system for human skills and knowledge sharing between one or more knowledge providers and one or more knowledge seekers according to claim 16, wherein the one or more knowledge providers search-results screen includes a ranking that includes a mix of one or more pay-per-minute knowledge-providers, one or more pay-per-session knowledge providers and one or more unpaid volunteer knowledge providers.

18. The system for human skills and knowledge sharing between one or more knowledge providers and one or more knowledge seekers according to claim 17, wherein the one or more knowledge providers will pay participants to receive information.

19. The system for human skills and knowledge sharing between one or more knowledge providers and one or more knowledge seekers according to claim 2, wherein the human skills and knowledge sharing non-transitory storage media provides an appointment calendar app screen to schedule a knowledge sharing session and functions to send pre-session reminders by email and texting to all participants in a scheduled knowledge sharing session.

20. The system for human skills and knowledge sharing between one or more knowledge providers and one or more knowledge seekers according to claim 19, wherein the appointment calendar app screen includes a month with a plurality of days and a plurality of hours and fractions of hours representing the dates and times when the one or more knowledge providers are available to share real-time knowledge.

21. The system for human skills and knowledge sharing between one or more knowledge providers and one or more knowledge seekers according to claim 19, wherein the appointment calendar app screen and reminder functions includes the one or more knowledge providers providing one or more ad hoc immediate sessions to transfer knowledge in real-time and future appointment dates and times as determined by a stated schedule of future appointment availability.

22. The system for human skills and knowledge sharing between one or more knowledge providers and one or more knowledge seekers according to claim 19, wherein the human skills and knowledge sharing non-transitory storage media provides a knowledge transfer session screen utilizing video-conferencing, audio-conferencing, multimedia-conferencing and texting on the client.

23. The system for human skills and knowledge sharing between one or more knowledge providers and one or more knowledge seekers according to claim 22, wherein the knowledge transfer session screen displays a name of the one or more knowledge providers, a session duration and a billing basis involving sessions requiring payment.

24. The system for human skills and knowledge sharing between one or more knowledge providers and one or more knowledge seekers according to claim 22, wherein the knowledge transfer session screen displays if a session is in progress.

25. The system for human skills and knowledge sharing between one or more knowledge providers and one or more knowledge seekers according to claim 2, wherein the human skills and knowledge sharing non-transitory storage media provides a post-session ratings screen.

26. The system for human skills and knowledge sharing between one or more knowledge providers and one or more knowledge seekers according to claim 25, wherein the post-session ratings screen includes a rating from knowledge, ability to assist and knowledge session success.

27. The system for human skills and knowledge sharing between one or more knowledge providers and one or more knowledge seekers according to claim 25, wherein the post-session ratings screen records a review by text, audio recording, or video recording as part of post-session mode.

28. The system for human skills and knowledge sharing between one or more knowledge providers and one or more knowledge seekers according to claim 25, wherein the system for human skills and knowledge sharing between one or more knowledge providers and one or more knowledge seekers provides pro bono knowledge from the one or more knowledge providers to the one or more knowledge seekers.

29. A method for human skills and knowledge sharing between one or more knowledge providers and one or more knowledge seekers, comprising the steps of:
logging into a system for human skills and knowledge sharing between the one or more knowledge providers and the one or more knowledge seekers;
searching the system for human skills and knowledge sharing between the one or more knowledge providers and the one or more knowledge seekers for the one or more knowledge providers;
selecting the one or more knowledge providers;
scheduling an appointment with the one or more knowledge providers;
conducting the appointment with the one or more knowledge providers;
rating and reviewing the session and one or more other session participants where all participating one or more knowledge seekers and all participating knowledge providers rate and review the session and one or more other parties to the session; and
paying the one or more knowledge providers the session service of knowledge sharing, if payment is required by the one or more knowledge providers.
